(19) United States
(12) Patent Application Publication
(10) Pub. No.: US 2009/0326935 A1
(43) Pub. Date: Dec. 31, 2009

(54) METHOD OF TREATING VOICE INFORMATION

(75) Inventor: Paavo Eskelinen, Oulu (FI)

Correspondence Address: CONNOLLY BOVE LODGE & HUTZ LLP, 1875 EYE STREET, N.W., SUITE 1100, WASHINGTON, DC, 20006, US

(73) Assignee: Head Inhimillinen Tekiji Oy, Oulu (FI)

(21) Appl. No.: 12/307,525

(22) PCT Filed: Jul. 7, 2007
(86) PCT No.: PCT/FI07/50413

§ 371 Date: Jan. 5, 2009

(30) Foreign Application Priority Data
Jul. 4, 2006 (FI) 20065474

(51) Int. Cl. G10L 19/00

(52) U.S. Cl. 704/230; 704/E19.001

(57) ABSTRACT

A method for compressing digital sound data in which method a sound signal is divided for encoding into temporal segments and the sound samples of a segment, which are originally presented by N0 number of bits, are requantized by one or more number of bits which are smaller than N0, is characterized in that an upper limit is set for the quantization error, and one of the greatest absolute sound samples of the segment is selected as a fixed point (xₚ) on the basis of which said smaller number of bits and the value of the quantization step are defined and such an amount of the sound samples of the segment are quantized by means of them that the upper limit of the quantization error is not exceeded, whereby the samples quantized in this way form a group of values associated to the fixed point (xₚ) concerned and quantized by said smaller number of bits and the value of the quantization step.

### FIELD OF THE INVENTION

The invention deals with a method to process sound information, where the sound signal to be encoded is divided into temporal segments each containing a certain amount of sound samples.

### BACKGROUND OF THE INVENTION

Lossy compression techniques are frequently applied to sound and image data. This is due to the fact that human capacity to comprehend information like sound and image is based on over all impression instead of detailed analysis. Examples of sound information compression can be found in the GSM standard, in the MP3 standard as well as in the A- and μ-law algorithms used in leased lines. These methods yield a suitable compression ratio with respect to their applications, which is important because of e.g. limited access and capacity in network connections or because of the requirement for sound quality.

The GSM method suits best for reproduction of sound by only one speaker, but the sound quality deteriorates substantially in reproducing music. The AMR (Adaptive Multi Rate) method possesses a clearly better sound quality than the GSM method., but the music quality is, however, generally not sufficient and lacks well behind the level achieved by the MP3 method.

Music can not be reproduced well enough by most of the existing mobile devices due to the insufficient power of the processing components decoding data produced by the more demanding compression algorithms like MP3. In more recent devices support for MP3 decoding is embedded.

This does not in any way set aside the problem that deals with music reproduction while watching videos in a mobile device. Rather extensive processing power is usually required to decode video data and in addition to this simultaneous good quality music data decoding would be necessary. The 3GPP standard targeted at encoding mobile videos has addressed the sound part by the AMR method, which as mentioned earlier is not sufficient for good quality music reproduction.

### SUMMARY OF THE INVENTION

The aim of the invention is to formulate a method to encode and decode sound, which would particularly reduce the number of calculations in decoding sound data and which would therefore be applicable to playing high quality voice and music in mobile devices with low power processors. Another purpose is to come about with a method which can improve the reproduction of music combined with video data in mobile devices.

To achieve these goals to compress digital sound data, where the sound signal is for decoding divided into temporal segments and the segment sound samples, which have originally been presented by N0 number of bits will be requantized by one or more number of bits, the number of each is less than N0, the present invention provides a method in accordance with the independent claim 1. The other claims define some embodiments of the method of the present invention.

In the present invention both encoding and decoding are simple processes calculation wise.

The method reduces distribution of quantum data at low signal values and on the other hand quantum values less than 8 bits can be utilized.

One particular advantage of this method is its decompression efficiency of compressed signal values: only one multiplication execution is required after possible lossless decoding of quantum data has been completed.

In this method the precision of the decoded approximate values tends to maximize in large sound sample values, when e.g. in the A and μ law methods the precision increases as the sound sample values get smaller and furthermore these methods do not exploit variations of contents and lengths in short sound segments. The A and μ law methods typically use tables in the encoding phase because logarithmic calculations would require too much processing power. The method of the present invention does not need tables requiring extra memory.

### BRIEF DESCRIPTION OF THE DRAWINGS

The present invention will be addressed in the following pages in more detail with reference to the accompanying drawings, wherein

FIG. 1 illustrates a schematic example of a sound signal and its division into temporal segments for encoding,

FIG. 2 illustrates an example of a single segment containing sound samples and

FIG. 3 illustrates another example of a single segment containing sound samples.

### DETAILED DESCRIPTION OF THE INVENTION

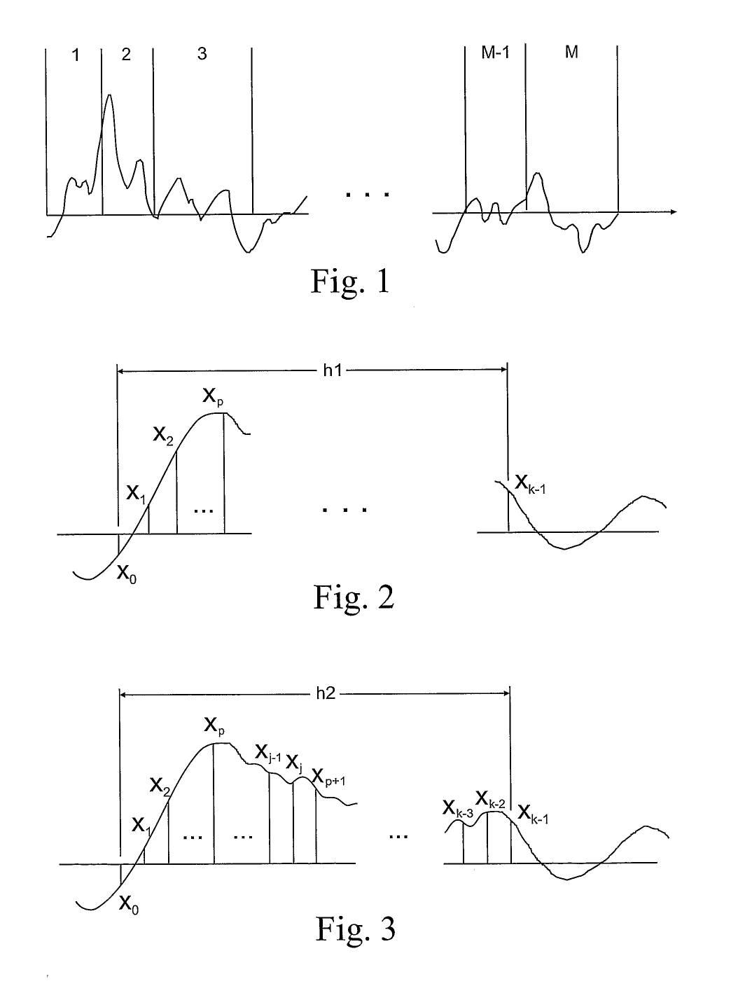

A sound signal of FIG. 1 to be encoded has been divided into temporal segments of variable lengths 1, 2, 3, . . . M−1, M. The lengths of these segments may also be the same.

FIG. 2 shows an example of a segment h1 consisting of k original sound samples {x₀, x₁, x₂, . . . , xₖ₋₁}ₕ. It is common practice to apply 16 bit precision to digitize a sound signal and also in this example the original sound samples have been digitized by the number of bits N0=16. In the method of the present invention the sound samples of the segment originally presented by N0 bits will be requantized by N number of bits, where N<N0.

In an embodiment a choice is first made which number of bits will be applied to encode the samples of the pertinent segment. N may e.g. be 6, which will result in compression efficiency of 62.5% when N0=16 before the final lossless compression.

Next a fixed point xₚ among the segment samples is selected which may be the almost greatest absolute value, which can be chosen so that the greatest absolute value is still expressible by the N number of bits or alternatively it may be the greatest absolute value xₘₐₓ. It is advantageous to perform the following calculations with all the values of xₚ satisfying the previous conditions because it is likely that one value of the fixed point xₚ will render a signal to noise ratio better that the others. Here we choose xₘₐₓ as the fixed point and the value of the quantization step qₕ(N) is calculated by dividing the previous value by the number 2^{N}−1:

qₕ(N)=xₘₐₓ/(2^{N}−1) (1)

Applying this quantization step value the samples can be presented with N bits:

χ_{qi}=xᵢ/qₕ(N) (2)

The decoding process will yield the approximate N-bit sample values accordingly:

xᵢ(qₕ)=χ_{qi}·qₕ (3)

Now the original samples will be quantized and decoded deploying all the possible quantization step values resulting from N bits and hence having a certain range of variation [q_{hMIN}, q_{hMAX}]. The total segment error is calculated for each quantization of the segment samples by every quantization step value, the error being e.g. the sum of the squares of the differences between the original N0-bit and the decoded N-bit approximate values based on the respective quantization step values.

The optimum quantization step value q_{hOPT} is the value which produces the smallest total error of the segment. This can be expressed e.g. as follows:

$${q}_{hOPT} = min \{ {\sum }_{i} {( {x}_{i} - {x}_{i} ( {q}_{h} ) )}^{2} \} , \qquad ( 4 )$$

where 0≦i<k

q_{hMIN}≦qₕ<q_{hMAX}

q_{hMIN}=xₘₐₓ/qₕ(N)

q_{hMAX}=xₘₐₓ/qₕ(N−1)

Besides the sum of the squares of the differences mentioned above the total error can be defined otherwise, e.g. the sum of the absolute differences of the original and the decoded approximate values.

The maximum value may also be substituted by a value close to the maximum one so that the quantization of the segment values does not exceed the number of bits N chosen.

Each segment to be encoded will be quantized by the said optimum quantization step of the segment. The encoding of the sound data will produce two series of numbers, the other of which contains the quantized values of the segment samples {{x₀, x₁, x₂, . . . , xₖ₁₋₁}₁, {x₀, x₁, x₂, . . . , xₖ₂₋₁}₂, {x₀, x₁, x₂, . . . , xₖ₂₋₁}₃, . . . , {x₀, x₁, x₂, . . . , x_{kM-1}}_{M}} and the other consists of the optimal quantization step values of the segments {q_{1OPT}, q_{2OPT}, . . . , q_{MOPT}}.

The latter number series does not necessarily have to use integers. The segments may be of the same or different length. The criterion to choose the number of sound samples and/or the number of bits N for a segment may e.g. be the segment signal to noise ratio after the quantization or the upper limit for the total amount of bits allowed for the quantization as it has been previously described. Other selection criteria may also be deployed.

In the above example to find the best i.e. the optimal value all the possible values of the quantization step were considered in an orderly fashion. To speed up the search for the quantization step value only a part of the possible quantization step values may be tried out for instance in the following ways:

a) only every k^{th} value within certain limits is considered

b) binary search is applied

c) a smaller set of values is arbitrarily selected

It is uncertain whether the best value will be found in any of the speed up cases. This is due to the fact that as the quantization step increases the total segment error may increase or decrease, i.e. the total error may change randomly. It is also possible to try more samples according to some algorithm if the speed up procedure for the segment does not bring about a satisfactory quantization step value.

Another option is to address all the values within an interval shorter than the interval enclosing all the possible values or to address all the values within several shorter intervals.

In this method the signal encoding criterion can also be the segment signal to noise ratio to which a certain minimum limit Sₘᵢₙ is imposed. Then to achieve this minimum limit it is possible to proceed in many different ways by suitably selecting the segment lengths and the corresponding values of the number of bits N.

In an embodiment the length of the selected segment is kept constant and the maximum value of the signal to noise ratio Sₖ(N) achievable with N bits is calculated referring to the case described earlier where the total error due to the approximation is the smallest. If Sₖ(N)<Sₘᵢₙ the value of N will be increased by one, i.e. N=N+1 and then the corresponding signal to noise ratio Sₖ(N) is calculated as before. This procedure is repeated until the target is reached, in other words until Sₖ(N)≧Sₘᵢₙ. If the first calculation yielded a signal to noise ratio greater than the minimum limit set, i.e. Sₖ(N)>Sₘᵢₙ, then the value of N is decreased by one, N=N−1 and then the maximum signal to noise ratio is calculated as before. This procedure is carried on until the goal is attained, Sₖ(N)<Sₘᵢₙ, in which case the value of N will be set to one greater than the previous value, meaning N=N+1 or the current N value if Sₖ(N)=Sₘᵢₙ. Here it is obvious that the value of N may be at any time changed by more than the value 1.

In an embodiment the number of bits N used to quantize the selected segment is chosen to be unchangeable and additionally for the first round of calculations the segment length is set to k=k₀. Using these as the starting values the greatest signal to noise ratio S_{N}(k) is calculated and if it falls below the set target, that is S_{N}(k)<Sₘᵢₙ then the segment length is cut to half, i.e. k=k₀/2. This procedure is continued until the minimum limit is reached so that S_{N}(k)>Sₘᵢₙ, in which case the segment value is increased by half of the previously decreased value which leads to a converging series of segment lengths for example as follows: {k₀, −k₀/2, −k₀/4, +k₀/8, −k₀/16, +k₀/32, . . . }, where the negative sign of the value indicates that the segment length has been decreased by that value and the positive sign indicates that the segment length has been increased by that value. The segment length is set to that value of k, which was the most recent to comply with the condition S_{N}(k)>Sₘᵢₙ or the value of k giving S_{N}(k)=Sₘᵢₙ. Other methods can also be applied to alter the segment length.

The segment division is an essential matter like also the selection of the number of bits and furthermore the fact that the size of the quantization step cannot be fixed beforehand because it depends on the maximum (or near the maximum) signal value of the segment after the number of bits has been first set. The length and the number of bits can be

a) set in advance or

b) either one or both can be adaptively determined according to some criterion which may for instance be the minimum limit of the segment signal to noise ratio or some other criterion pertaining to one or several segments.

In an embodiment both the segment length k and the number of bits N expressing a signal value is changed either simultaneously or alternating in some suitable manner so that any single segment will have its signal to noise ratio at least equal to the set minimum limit. In an embodiment both the segment length k and the number of bits N expressing a signal value is changed either simultaneously or alternating in some suitable manner so that any single segment will have its signal to noise ratio at least equal to the set minimum limit and the total number of bits required to express the signal approximate values by the end of the encoding is the smallest possible.

In an embodiment the minimum limit of the average signal to noise ratio of two or more segments is used as the encoding criterion. In this case the signal to noise ratio of one or more segments may fall below the minimum limit as other segments exceed the minimum value.

In an embodiment the upper limit of the total number of bits accumulated as a result of the encoding is used as the criterion of the encoding. Now the embodiments described above may be applied to minimize the total signal error.

In case the lengths of the segments and/or the number of bits N used for expressing the signal values then the corresponding number series {k₁, k₂, k₃, . . . , k_{M}} and/or {N₁, N₂, N₃, . . . , N_{M}} will be included in the encoding data.

These number series or the differences between the series members may often be compressed by some lossless compression method to minimize the total number of bits produced. In addition to this it may be possible to still reduce the total number of bits by expressing the signs of the quantum values as a separate series.

Below several procedures are presented to select the signal samples for the quantization in order to attain more efficient compression ratios compared to the quantization based on the direct selection of all the signal samples.

In FIG. 3 in the segment h2 a fixed point xₚ is first selected which can be the absolute maximum or almost the absolute maximum value of the segment samples as described earlier.

The number of bits N to quantize a sample is set together with either 1) the maximum allowed quantization error of any single sample or 2) the maximum allowed average quantization error of the selected samples or 3) the maximum allowed average quantization error of the selected samples combined with the maximum allowed standard deviation of the quantization error or combined alternatively with some other useful statistical parameters. As described earlier the quantization error may be expressed by means of the signal to noise ratio.

If the quantization error criterion is applied to a single sample then after each quantization using the symbols defined previously the absolute value of the quantization error is calculated as follows:

eᵢ=|xᵢ−xᵢ(qₕ)| (5 )

The sample is tagged quantized and belonging to the group Gₚ of the firstly chosen fixed point xₚ if the calculated error does not exceed the maximum allowed quantization error eₘₐₓ that is

xᵢ(qₕ)εGₚ, when eᵢ≦eₘₐₓ (6)

In case some samples were not included in the Gₚ group the next fixed point xₚ₊₁ will be chosen among these samples after which the next fixed point or the sample group Gₚ₊₁ is made up according to the procedure above. This mode of operation is continued until all the segment samples belong to some sample group. In case there will in the segment be groups with only one member then 1) these groups may be ungrouped i.e. their samples are tagged free belonging to no groups after which the number of bits N will be increased by one and a recalculation is performed addressing these samples or 2) the segment length is altered and a recalculation is executed in part or in all of the groups.

In FIG. 3 the two fixed point groups could be formed as follows: Gₚ={x₁, x₂, . . . , xₚ, xⱼ₋₁, . . . xₖ₋₃}ₕ₂ and Gₚ₊₁={x₀, . . . , xⱼ, xₚ₊₁, . . . , xₖ₋₂, xₖ₋₁}ₕ₂. The quantization step values associated with the fixed points could also be encoded based on their differences.

If the maximum allowed average quantization error serves as the selection criterion then e.g. after having calculated each value of eᵢ the average error is estimated and compared to the maximum value of the corresponding error and consequently xᵢ is either tagged to belong to the currently handled group or it still remains a free sample. In the similar fashion in the standard deviation case the corresponding calculation is performed and the comparison is made to the maximum allowed standard deviation.

In a simple embodiment there are only two fixed points in a segment in which case tagging a sample to a group can be expressed by one bit. In another simple embodiment a group of index series is defined as in the two fixed point case by associating some periodic index series to one fixed point group and hence all the other indices will always belong to the other fixed point group, in which case no additional information is needed for tagging an individual sample to a group. This kind of a periodic index series can be formed to any desired number of fixed points in a segment by calculations by selecting the period length so that the total error of the fixed point group is the smallest e.g. according to the equation (4).

Suitable index series may also be generated by first encoding the sound signal and at the same time storing all the generated index series and then selecting a suitable smaller number of the most frequently used or almost similar index series and then reencoding the sound signal using and selecting those index series producing the best encoding result, the series of which or their index differences may still be compressed by lossless methods.

In all cases the final decision to select samples in a segment can be done by comparing the one fixed point case to the several fixed points case, where the criterion might e.g. be an optimal ratio between the compression bit load and the signal to noise ratio of the segment.

The invention may vary within the scope of the accompanying claims.

1. Method for compressing sound data in which method a sound signal is divided for encoding into temporal segments and the sound samples of a segment which are originally presented by N0 number of bits are requantized by one or more number of bits which are smaller than N0, characterized in that:
an upper limit is set for the quantization error,
one of the greatest absolute sound samples of the segment is selected as a fixed point (xₚ) on the basis of which said smaller number of bits and the value of the quantization step are defined and such an amount of the sound samples of the segment are quantized by means of them that the upper limit of the quantization error is not exceeded, whereby the samples quantized in this way form a group of values associated to the fixed point (xₚ) concerned and quantized by said smaller number of bits and the value of the quantization step.

2. Method according to claim 1, characterized in that it further includes selecting another one of the greatest absolute sound samples of the segment as another fixed point (xₚ₊₁), whereby the samples quantized respectively form another group of values associated to said another fixed point.

3. Method according to claim 1, characterized in that the quantization error for which the upper limit is set is the quantization error of a single sample.

4. Method according to claim 1, characterized in that the quantization error for which the upper limit is set is for the quantization of each sample the average quantization error of the samples quantized till that.

5. Method according to claim 1, characterized in that the quantization error for which the upper limit is set is for the quantization of each sample the standard deviation of the quantization errors of the samples quantized till that.

6. Method according to claim 1, characterized in that the quantization error is indicated by means of the signal to noise ratio.

7. Method according to claim 1, characterized in that the value of the quantization step is determined by dividing the value of the sample (xₚ,xₚ₊₁) selected as a fixed point by the number 2^{N}−1 in which N is the number of bits, smaller than the N0 number of bits, used in the quantization.

8. Method according to claim 1, characterized in that the value of the quantization step is determined by trying different values according to a certain algorithm or randomly and by selecting the value producing the smallest quantization error.

9. Method according to claim 1, characterized in that the samples of a segment are quantized by using both one and more than one fixed points and selecting a suitable alternative by comparing the results with each other.

10. Method according to claim 1, characterized in that the basis for the selection is as optimal relation as possible of the signal to noise ratio and the bit load needed for the compression.
